(19) United States
(12) Patent Application Publication
(10) Pub. No.: US 2017/0039653 A1
(43) Pub. Date: Feb. 9, 2017

(54) DATA ANALYTICS AND PREDICTIVE METHOD

(71) Applicant: Gregory A. Lewis, Brooklyn, NY (US)

(72) Inventor: Gregory A. Lewis, Brooklyn, NY (US)

(21) Appl. No.: 15/224,787

(22) Filed: Aug. 1, 2016

Related U.S. Application Data
(60) Provisional application No. 62/201,614, filed on Aug. 6, 2015.
(60) Provisional application No. 62/368,265, filed on Jul. 29, 2016.

(51) Int. Cl. G06Q 40/06; G06Q 40/04

(52) U.S. Cl. CPC G06Q 40/06; G06Q 40/04

(57) ABSTRACT

A financial and market analytics and prediction method, including a method for performing market portfolio and trading performance analytics and prediction and market portofolio and trading risk analytics and prediction.

### CROSS REFERENCE TO RELATED APPLICATIONS

This application claims the benefit of U.S. Ser. No. 62/201,614, filed Aug. 6, 2015 and incorporated herein by reference. This application also claims the benefit of U.S. Ser. No. 62/368265, filed Jul. 29, 2016 and incorporated herein by reference.

### BACKGROUND OF THE INVENTION

Field of the Invention

The present invention relates generally to the field of data analytics and predictions. More specifically, certain embodiments of the present invention relate to the field of financial and market analytics and prediction, including among other specific fields market portfolio and trading performance analytics and prediction and market portfolio and trading risk analytics and prediction.

Description of the Related Art

Performance and risk analtyics are known in various fields of endeavor. For example, a known analytics system, commonly referred to as “Sabermetrics”, is applied to the sport of baseball.

In systems such as Sabermetrics, statistical analysis is applied to baseball records, for example, to analyze and evaluate, both directly and comparatively, the performance of individual players. Applying Sabermetrics, statisticians my examine parameters such as number of at bats, number of home runs, number of strikeouts, number of pitches thrown, quantitative and qualitative pitching “style”, types of pitches thrown, average number of innings pitched, earned run average, runs batted in, number of stolen bases, and on base percentage.

Through the application of performance and risk analytics, practitioners of Sabermetrics my effectively predict players' future performance and risk (sometimes referred separately or together as “performance”).

There exists a need for performance and risk analytics and predictive analytics in connection with market portfolios and market trading portfolios. Such performance and risk analytics and predictive analytics is rendered non-trivial to create and implement because of the non-triviality of selecting useful parameters and determining the proper analytical functions to apply to such parameters.

### SUMMARY OF THE INVENTION AND PREFERRED EMBODIMENTS

The objects and features of the invention may be understood with reference to the following detailed description of an illustrative embodiment of the present invention

Critical to the proper operation of the present invention is the selection of relevant analytical parameters (i.e., relevant and useful data points, sometimes called risk/performance parameters) and determining the proper analytical functions to apply to such parameters (e.g., to determine the proper weighting, functions, transformations and analytics to apply to such parameters).

Certain embodiments of the present invention consider seven preferred analytical parameters as follows: (1) year to date (“YTD”) returns; (2) use of margin; (3) diversification, including diversification of portfolio; (4) trading frequency/volume (also referred to, for example, as “number of trades per month”); (5) dividend income; (6) quantified “x-factor” parameters; and (7) past performance consistency.

Year to date returns (sometimes called “absolute return”) concern one or both of short and long term percentage of returns on investment. Year to date returns may be a most important parameter. Educated investors may closely monitor year to date returns of a market portfolio for a predetermined time period and may compare such returns to market benchmarks such as S&P 500 and Dow Jones indexes.

As will be appreciated by those of skill in the art, returns for other periods may be substituted for the year to date period without departing from the present invention.

The use of margin parameter may represent a quantification of the amount of borrowing inherent in a portfolio being analyzed. This may alternatively be referred to as the amount of leverage of a portfolio. Servicing and margin and margin calls (lenders' demands for payments against margin borrowed) may be quantified in this parameter.

The diversification parameter may quantify market risks associated with substantive characteristics of elements of a portfolio. By way of example, characteristics such as variation in the field if industry of equity instruments, risk rating of debt instruments and types of instruments contained in the portfolio, among others, may be quantified in this parameter.

As used herein, a “financial instrument” (sometimes referred to as an “instrument”) is any tradable asset of any kind.

Another parameter that may be included in analytics is trading volume. This parameter may quantify the number of trades or transactions performed by a portfolio actor (such as a stock broker or trader, for example) during a specified period of time. Higher values may be assigned to lower trading volumes and lower values to higher trading volume (e.g., in cases of “churning”). This parameter may quantify, for example, the lower value (in the form of increased fees, for example) received by retail stock portfolio owners when employing high volume or actively trading financial professionals.

The dividend parameter may quantify the value to a portfolio realized by the receipt of dividends, interest or other generated payments from elements of a portfolio. For example, ordinary dividends on stock portfolios may be quantified in this parameter.

Behavioral factors may be quantified in x-factor parameter. For example, a portfolio actor's behaviors may affect the analytics and predictions of the present invention. Behaviors may include the use of trading tools and structures such as stop losses or covered calls to stop, limit or offset portfolio losses. Other behaviors may include commissions charged, liquidity of portfolio, commission to net gain ratio, number of booked winners, frequency of winners, number of booked losers, frequency of losers, commission fees paid, use of stop loss, use of call/put options (sold or bought), passive or aggressive behaviors, average profit per trade, average loss per trade and money turn over ratio, debt to equity ratio, and the like. By way of example, values assigned to the x-factor parameter may be as follows: 0.5 if a portfolio utilizes or generates any type of option premium; 0.5 if a portfolio utilizes 2 or more stop losses; 0.5 if a portfolio's commissions divided by that month's gains is less than 1%; 0.5 if a portfolio of 50% or more of readily liquidatable positions (e.g., stocks, bonds, mutual funds, etc.).

A final parameter may be consistency, that is, a history of positive outcomes with significant time invariance. The consistency parameter may assess overall positive outcomes, or may assess the time invariance of positive outcomes of each of the other parameters, or a combination of both. In certain embodiments of the present invention, the consistency parameter is weighted more heavily than other parameters to reflect a high importance of this parameter. In certain embodiments, the consistency parameter may be assigned values on a monthly basis based on the performance of a portfolio in each of the other parameters. For example, the consistency parameter may be assigned values as follows: 0.5 for a month where either the realized or unrealized year to date sub parameters (described more fully below) are net positive; 0.5 for a month where margin use is below 30% of the portfolio value; 0.5 for a month where a portfolio receives at least 1 point on the diversification parameter; 0.5 for a month where a portfolio receives at least 0.5 points on the trade frequency/volume parameter; 0.5 for a month where a portfolio receives at least 0.5 points on the dividend income parameter; 0.5 for a month where a portfolio receives at least 0.5 points on x-factor parameter.

As will be understood by those of skill in the art, other parameters may be included in the method of the present invention without departing from the invention disclosed.

The foregoing parameters may be assigned values and weights. By assigning values to each parameter, each parameter is quantified, thereby permitting the application of analytical functions to the parameters to reach a predictive result.

In certain embodiments of the present invention, the foregoing seven parameters are each assigned a value between 0 and 10 for a given market portfolio. The values reflect the quantitative assessment of the parameter in relation to the portfolio being analyzed. Higher numbers reflect higher value and lower numbers reflect lower value.

The values thus assigned may be further assigned weights, that is, multipliers associated with each parameter. By weighting the values thus assigned, the relative importance of parameters may be quantified. In this manner, more important parameters may be weighted more heavily (by applying a greater multiplier) and less important parameters me by weighted more lightly (by applying a lesser multiplier).

The several parameters may be further reduced (i.e., divided or split) into sub parameters to more precisely quantify and analyze portfolio performance.

In certain embodiments, the year to date return parameter may be reduced to sub parameters such as year to date realized gains and year to date unrealized gains. In certain embodiments, the year to date realized (booked) gains and losses may be summed and the year to date realized gains sub parameter may be assigned a value of, for example, 1, if the resulting sum is positive. Likewise, in certain embodiments, the year to date unrealized (unbooked) gains and losses may be summed and the year to date unrealized gains sub parameter may be assigned a value of, for example, 1, if the resulting sum is positive.

Similarly, in certain embodiments, the margin use parameter may be reduced to sub parameters which quantify the use of margin by comparison of a portfolio's margin use relative to some predetermined bench mark. For example, a sub parameter may be applied or quantified based on the use of margin in excess of a certain predetermined value, which may be percentage of total portfolio value or some other measure. Likewise, a margin use sub parameter may be quantified where the use of margin is below such a predetermined value. In certain embodiments, where a portfolio's margin is greater than 30% of the portfolio equity, the margin sub parameter may be assigned a value of 0, and where a portfolio's margin is less than 30% of the portfolio equity or all trades are transacted in case, the margin sub parameter may be assigned a value of 1.

The diversification parameter may be reduced in certain embodiments to a number of sub parameters. One such sub parameter may quantify the percentage of the total portfolio value comprised on a small number of assets or a single asset. For example, in the case of a portfolio of stocks, this sub parameter may quantify negatively (i.e., with a low value, not necessarily a negative number) a portfolio having a single stock comprising a percentage of the portfolio's total value above some predetermined bench mark. For example, where a portfolio has more than 30% of its total value in any one stock, the percentage of the total portfolio value in a single stock sub parameter may be assigned a value of 0, and the same sub parameter may be assigned a value of 1 in the contrary case. Alternatively, this sub parameter may be assigned a value according to a formula that considers total portfolio value and concentration (i.e., greater percentages of portfolio value in fewer instruments).

Two additional sub parameters into which the diversification parameter may be reduced are asset class and asset sector concentrations, with more favorable quantification for more diversification in the area under examination.

In connection with the asset class sub parameter, the sub parameter may quantify the degree of diversification of asset classes in the portfolio. In this context, an asset class may be defined as a group of securities that exhibits similar characteristics, behaves similarly in the marketplace and is subject to the same laws and regulations, including, for example, equities, or stocks; fixed income, or bonds; cash equivalents; money market instrument; real estate; commodities, and other types of investments. For example, this sub parameter may be assigned a value of 0.5 where a portfolio has no less than four different asset classes (sometimes called “industries”) and 0 if the contrary is true.

Likewise, in connection with the asset sector sub parameter, the sub parameter may quantify the degree of diversification of asset sectors represented in the portfolio. In this context, a sector may be defined as an area of the economy in which businesses share the same or a related product or service, including, for example, the extraction and harvesting of natural products from the earth (e.g., agriculture, mining and forestry); processing, manufacturing and construction; services, such as retail sales, entertainment and financial services; and intellectual pursuits, like education. Alternatively or additionally, a sector may be defined as an industry or market sharing common characteristics, as in, for example, technology, health care, energy, utilities and telecommunications. Under either definition, each sector may have unique characteristics and different risk profiles. For example, this sub parameter may be assigned a value of 0.5 where a portfolio has no less than four different sectors and 0 if the contrary is true.

Finally, in certain embodiments of the present invention, a “number of positions” sub parameter quantifies aspects of the diversification parameter. This sub parameter assigns a value based on the number of positions represented in a portfolio. In this context, positions may be defined as the amount of a security, commodity, currency or other instrument that is owned (in the case of a long position) or borrowed (in the case of a short position) in a portfolio, and may include spot (i.e., current) or future positions (i.e., options and the like). As with other sub parameters discussed herein, this sub parameter may be assigned a value by assessing the number of positions relative to some predetermined bench mark or according to a formula. For example, this sub parameter may be assigned a value of 0.5 where a portfolio has no less than four positions and 0 if the contrary is true.

Next, in certain embodiments of the present invention, the trading frequency/volume parameter may be reduced to sub parameters that are assigned values based on the number of trades in one or more predetermined periods relative to benchmarks for such periods and/or by application of a formula that considers such data. For example, sub parameters of the trading frequency/volume parameter may be assigned values where the number of trades for give portfolio in a given month exceed a predetermined number, e.g., four. In such embodiments, the frequency/volume parameter may be assigned a value of 0.5 where a portfolio has had 4 or less trades in a month and 0 if the contrary is true.

The dividend income parameter may, in certain embodiments, be reduced to sub parameters which are assigned values based on the collection or non-collection of dividends. This sub parameter may be assigned a value by assessing the number of portfolio elements that return dividends relative to some predetermined bench mark, by assessing a ratio of dividend producing to non-dividend producing portfolio elements, according to a formula that considers the amount of dividends returns, or according to a formula that assesses a combination of such factors. For example, this sub parameter may be assigned a value of 0.5 where a portfolio receives any dividend income and 0 if the contrary is true.

Although the particular embodiments shown and described above will prove to be useful in many applications in the art to which the present invention pertains, further modifications of the present invention will occur to persons skilled in the art. All such modifications are deemed to be within the scope and spirit of the present invention as defined by the appended claims.

The foregoing summary is not intended to limit the scope of the disclosure contained herein nor limit the scope of the appended claims. To the contrary, as will be appreciated by those persons skilled in the art, variations of the foregoing described embodiments may be implemented without departing from the claimed invention.

What is claimed is:

1. A method of predictive analysis of an investment portfolio comprising the steps of
determining for the investment portfolio risk/performance parameters;
assigning each parameter an initial value of 0;
assigning new values to the parameters based on an analysis of the parameters; and
assigning a value predictive of future performance based on a cumulative scoring of the parameters.

2. The method of claim 1, wherein the parameters are selected from the group consisting of: year to date (“YTD”) returns; use of margin; diversification, including diversification of portfolio; trading frequency/volume; dividend income; quantified x-factor parameters; and past performance consistency.

3. The method of claim 2, wherein the quantified x-factor parameters are selected from the group consisting of: portfolio utilizes or generates any type of option premium; portfolio utilizes 2 or more stop losses; portfolio commissions divided by current month's gains is less than 1%; portfolio of 50% or more of readily liquidatable positions of one or more of stocks, bonds and mutual funds.

4. The method of claim 2, wherein the step of assigning new values to the parameters based on an analysis of the parameters comprises the step of assigning the consistency parameter values as follows: 0.5 for a month where either a realized or unrealized year to date sub parameters is net positive; 0.5 for a month where margin use is below 30% of the portfolio value; 0.5 for a month where the portfolio receives at least 1 point on the diversification parameter; 0.5 for a month where the portfolio receives at least 0.5 points on the trade frequency/volume parameter; 0.5 for a month where the portfolio receives at least 0.5 points on the dividend income parameter; 0.5 for a month where the portfolio receives at least 0.5 points on x-factor parameter.

5. The method of claim 2, wherein the step of assigning new values to the parameters based on an analysis of the parameters comprises the steps of:
calculating a trading frequency/volume;
assigning the trading frequency/volume parameter may a value of 0.5 if the calculated trading frequency/volume is 4 or less trades in a month.

6. The method of claim 2, wherein the step of assigning new values to the parameters based on an analysis of the parameters comprises the steps of:
calculating a sum of year to date realized gains and losses;
assigning a year to date realized gains sub parameter of the year to date returns parameter a value of 1 if the sum of year to date realized gains and losses is positive;
calculating a sum of year to date unrealized gains and losses;
assigning a year to date unrealized gains sub parameter of the year to date returns parameter a value of 1 if the sum of year to date unrealized gains and losses is positive.

7. The method of claim 2, wherein the step of assigning new values to the parameters based on an analysis of the parameters comprises the steps of:
determining whether the portfolio has more than 30% of its total value in any one financial instrument,
assigning a total portfolio value in a single stock sub parameter a value of 1 if said determination indicates that the portfolio does not have more than 30% of its total value in any one financial instrument.

8. The method of claim 2, wherein the step of assigning new values to the parameters based on an analysis of the parameters comprises the steps of:
determining whether the portfolio has has no less than four different asset classes;
assigning an asset class sub parameter a value of 0.5 said determination indicates that the portfolio has no less than four different asset classes.

9. The method of claim 2, wherein the step of assigning new values to the parameters based on an analysis of the parameters comprises the steps of:
determining whether the portfolio has has no less than four different asset sectors;
assigning an asset sector sub parameter a value of 0.5 said determination indicates that the portfolio has no less than four different asset sectors.

10. The method of claim 2, wherein the step of assigning new values to the parameters based on an analysis of the parameters comprises the steps of:
determining whether the portfolio has has no less than four positions;
assigning a number of positions sub parameter a value of 0.5 said determination indicates that the portfolio has no less than four positions.

11. A method of predictive analysis of an investment portfolio comprising the steps of determining for the investment portfolio risk/performance parameters;
assigning to each parameter an initial value of 0;
assigning new values to the parameters based on an analysis of the parameters; and
assigning a value predictive of future performance based on a cumulative scoring of the parameters;
wherein the quantified x-factor parameters are selected from the group consisting of:
portfolio utilizes or generates any type of option premium; portfolio utilizes 2 or more stop losses; portfolio commissions divided by current month's gains is less than 1%;
portfolio of 50% or more of readily liquidatable positions of one or more of stocks, bonds and mutual funds;
and wherein the step of assigning new values to the parameters based on an analysis of the parameters comprises the steps of:
a) assigning a consistency parameter values as follows: 0.5 for a month where either a realized or unrealized year to date parameters is net positive; 0.5 for a month where margin use is below 30% of the portfolio value; 0.5 for a month where the portfolio receives at least 1 point on the diversification parameter; 0.5 for a month where the portfolio receives at least 0.5 points on the trade frequency/volume parameter; 0.5 for a month where the portfolio receives at least 0.5 points on the dividend income parameter; 0.5 for a month where the portfolio receives at least 0.5 points on x-factor parameter;
b) calculating a trading frequency/volume and assigning a trading frequency/volume parameter a value of 0.5 if the calculated trading frequency/volume is 4 or less trades in a month;
c) calculating a sum of year to date realized gains and losses and assigning a year to date realized gains parameter a value of 1 if the sum of year to date realized gains and losses is positive;
d) calculating a sum of year to date unrealized gains and losses and assigning a year to date unrealized gains parameter a value of 1 if the sum of year to date unrealized gains and losses is positive;
e) determining whether the portfolio has more than 30% of its total value in any one financial instrument and assigning a total portfolio value in a single stock parameter a value of 1 if said determination indicates that the portfolio does not have more than 30% of its total value in any one financial instrument;
f) determining whether the portfolio has has no less than four different asset classes and assigning an asset class parameter a value of 0.5 if said determination indicates that the portfolio has no less than four different asset classes;
g) determining whether the portfolio has has no less than four different asset sectors and assigning an asset sector parameter a value of 0.5 said determination indicates that the portfolio has no less than four different asset sectors;
h) determining whether the portfolio has has no less than four positions and assigning a number of positions parameter a value of 0.5 if said determination indicates that the portfolio has no less than four positions.
